(19) United States
(12) Patent Application Publication
(10) Pub. No.: US 2004/0065647 A1
(43) Pub. Date: Apr. 8, 2004

(54) Die bonder

(75) Inventors: Yuichi Kubo, Mitaka-shi (JP); Masateru Osada, Mitaka-shi (JP); Masayuki Azuma, Mitaka-shi (JP)

Correspondence Address: NIXON PEABODY, LLP, 401 9TH STREET, NW, SUITE 900, WASINGTON, DC, 20004-2128, US

(73) Assignee: Tokyo Seimitsu Co., Ltd., Tokyo (JP)

(21) Appl. No.: 10/663,726

(22) Filed: Sep. 17, 2003

(30) Foreign Application Priority Data
Sep. 18, 2002 (JP) 2002-271266

(51) Int. Cl. B23K 26/00

(52) U.S. Cl. 219/121.61

(57) ABSTRACT

The die bonder which mounts dies piece by piece on a base has a laser machining part which causes laser light to become incident from the obverse surface of a wafer and forms a modified region in the interior of the wafer. In this manner, the die bonder itself has the function of dividing the wafer into individual dies. Thus, the dicing step before the die bonding step can be omitted.

### BACKGROUND OF THE INVENTION

1. Field of the Invention

The present invention relates to a die bonder which mounts dies of semiconductor devices, electronic parts, etc. one by one on a base.

2. Description of the Related Art

Conventionally, a die bonder which bonds dies (also called chips) of semiconductor devices, electronic parts, etc. on a base piece by piece is used in the assembly process of semiconductor devices, electronic parts, etc. Since the die bonder does not have the function of dividing a wafer having a surface on which a large number of semiconductor devices, electronic parts, etc. are formed into individual dies, it is necessary to provide a dicing step of dividing the wafer into individual dies before the die bonding step.

In the dicing step of dividing the wafer into individual dies, a dicing device which cuts the wafer by cutting ground grooves into the wafer by use of a thin grinding wheel called a dicing blade has been used. The dicing blade is fabricated by electrodepositing fine abrasive grains of diamond with nickel and an ultrathin type of about 30 μm in thickness is in use.

The dicing blade is rotated at high speeds of 30,000 to 60,000 rpm and caused to cut into the wafer to perform complete cutting (full cut) or incomplete cutting (half cut or semifull cut). The half cut refers to a method by which the dicing blade is caused to cut into the wafer to about half the thickness of the wafer, and the semifull cut refers to a method by which ground grooves are formed with a remaining thickness of about 10 μm left behind.

In the case of grinding by use of the dicing blade, however, since the wafer is a highly brittle material, brittle mode grinding is performed and chipping occurs on the obverse surface and/or the reverse surface of the wafer. The chipping has mainly caused a decrease in the performance of divided dies. Furthermore, since a large amount of water, such as grinding water and cleaning water, is used in the dicing device, this provides a main factor in an increase in running costs including the waste water purifying cost.

In place of cutting by the conventional dicing blade, a laser dicing device has been proposed as a device for solving the problem of the chipping in the dicing step. The laser dicing device causes laser light to be incident, with a light focusing point aligned within the wafer, and forms within the wafer a modified region by multiphoton absorption thereby to divide the wafer into individual chips (for example, refer to Japanese Patent Application Publication Nos. 2002-192367, 2002-192368, 2002-192369, 2002-192370, 2002-192371 and 2002-205180). The proposed laser dicing devices are based on dividing technology using laser light. In these laser dicing devices, laser light is caused to be incident from a surface of the wafer and a reformed region is formed within the wafer, whereby the wafer is divided from this reformed region as an initiation point.

However, the laser dicing devices differ from dicing devices using a dicing blade only in the mechanism of dicing and are still dicing devices, and the dicing step is still required before the die bonding step.

### SUMMARY OF THE INVENTION

The present invention has been made in view of such a situation and has as its object the provision of a die bonder capable of omitting the dicing step before the die bonding step.

In order to attain the above-described object, the present invention is directed to a die bonder which mounts on a base piece by piece, the dies each having a surface on which a semiconductor device is formed, the die bonder comprising: a laser machining part which causes laser light to become incident from a surface of a wafer before dividing into individual dies so that the laser light forms a modified region within the wafer, wherein the wafer is divided into individual dies in the laser machining part.

According to the present invention, since a die bonder which mounts dies piece by piece on a base has a laser machining portion, the die bonder itself has the function of dividing the wafer into individual dies and can omit the dicing step before the die bonding step. Thus, the whole assembly process is simplified, with the result that it is possible to reduce floor space and power.

All dies on the wafer may be divided into individual dies by the laser machining part. According to the present invention, the control of the relative movement of the wafer to laser light becomes simple because laser light is caused to be incident upon all dies on the wafer.

Alternatively, only conforming dies on the wafer may be divided into individual dies by the laser machining part. According to the present invention, efficiency is high because laser light is caused to be incident upon only conforming dies. The efficiency increases especially because useless irradiation with laser light is not performed when the number of conforming dies on the wafer is small.

Preferably, a product type marking is provided on a surface of the die by the laser machining part. According to the present invention, it is possible to omit a marking process in which a device only for marking is used, because a product type marking is provided on a surface of the die by the laser machining portion for die dividing. If only conforming dies are marked, it is possible to perform product type marking more efficiently.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a schematic block diagram of the configuration of a die bonder according to an embodiment of the present invention;

FIG. 2 is a schematic diagram of the arrangement of each part of the die bonder;

FIG. 3 is a schematic diagram of the configuration of a laser machining part;

FIG. 4 is a perspective view of a wafer mounted on a frame;

FIGS. 5(a) and 5(b) are schematic diagrams to explain modified regions formed within a wafer; and

FIG. 6 is a schematic diagram to explain the operation of an expanding part and a pickup part.

### DETAILED DESCRIPTION OF THE PREFERRED EMBODIMENTS

A preferred embodiment of a die bonder related to the present invention will be described in detail below on the basis of the attached drawings.

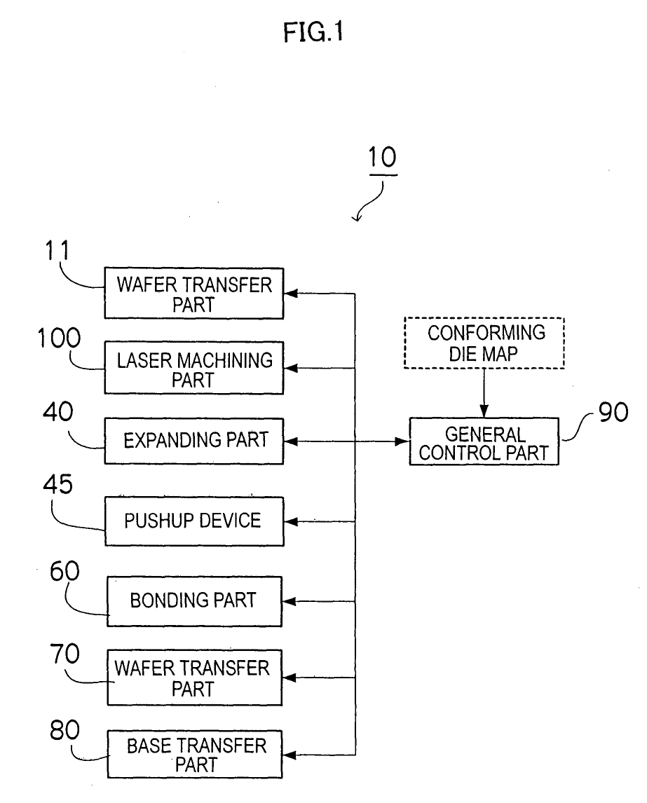

FIG. 1 is a schematic configuration diagram of a die bonder according to an embodiment of the present invention. As shown in FIG. 1, a die bonder 10 comprises a wafer transfer part 11, a laser machining part 100, an expanding part 40, a pushup device 45, a bonding part 60, a wafer transfer part 70, a base transfer part 80, a general control part 90, etc.

The wafer transfer part 11 transfers a wafer during the laser machining of the wafer and during the pushup and pickup of dies. The laser machining part 100 performs machining for dividing the wafer into individual dies. The expanding part 40 expands a wafer tape on which the wafer is stuck and widens the gaps between individual dies. The pushup device 45 pushes up the dies from the side of the expanded wafer tape side to facilitate a pickup.

The bonding part 60 mounts picked-up dies on a base. The wafer transfer part 70 transfers the wafer to each part and the base transfer part 80 transfers the base before and after bonding. The general control part 90 has an input/output circuit part, a processing part (CPU), a storage part, etc. and controls each part of the die bonder 10.

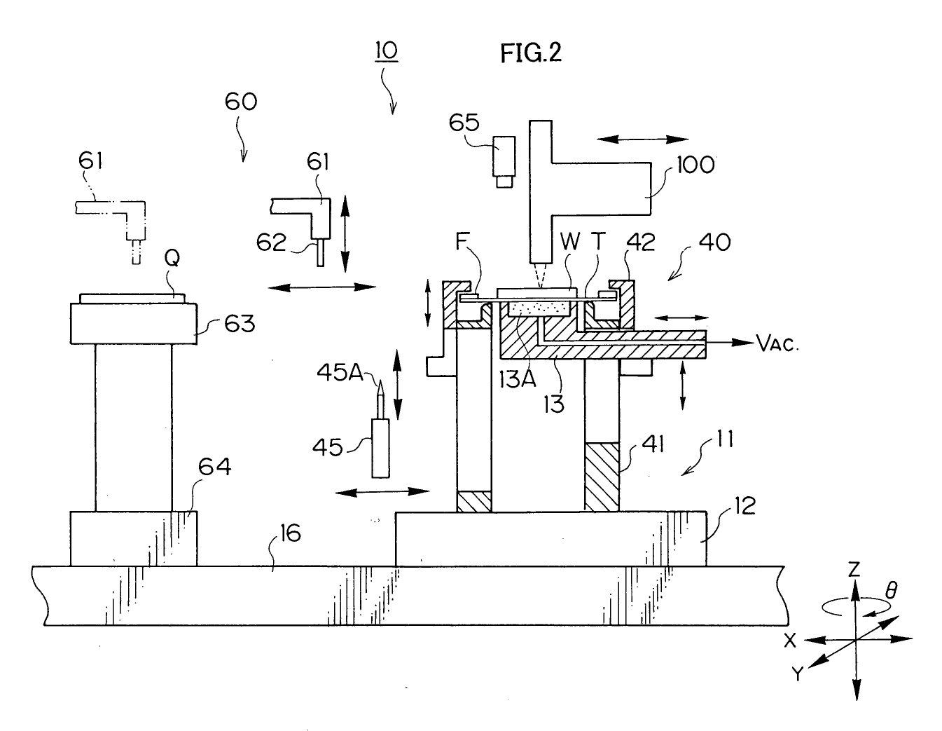

FIG. 2 is a schematic diagram of the arrangement of each part of the die bonder 10. As shown in FIG. 2, the wafer transfer part 11 comprises an XYZθ table 12 installed on a main body base 16 of the die bonder 10, a holding stage 13 which is placed on the XYZθ table 12 and holds a wafer W via a dicing tape T by suction, etc. The wafer W is precisely transferred by the transfer part 11 in the directions of XYZθ in the drawing.

The holding stage 13 holds the wafer W during laser machining, and a porous member 13A is incorporated in the holding surface of the holding stage to hold the wafer W uniformly by a vacuum force. Except during laser machining, the holding stage 13 moves to a retreat position by use of a drive device (not shown).

The expanding part 40 comprises an expanding stage 41 placed on the XYZθ table 12 and a frame pusher 42. The frame pusher 42 is transferred by a driving device (not shown) in the Z direction and pushes down a frame F on which the wafer W is mounted via the wafer tape T. Thus, the wafer tape T is radially expanded, and the gaps between dies are widened.

The pushup device 45 pushes up dies by use of one or more needles 45A provided at the leading end thereof from the side of the expanded wafer tape T.

The bonding part 60 comprises a collet 62 which holds the pushed up dies by suction, a collet holder 61 which has the collet 62 at the leading end thereof, a base stage 63 to place a base Q thereon, a base transfer table 64 which place the base stage 63 thereon and transfers the base Q in the XY directions, a die recognition camera 65 which recognizes a die to be picked up by use of the collet 62, etc.

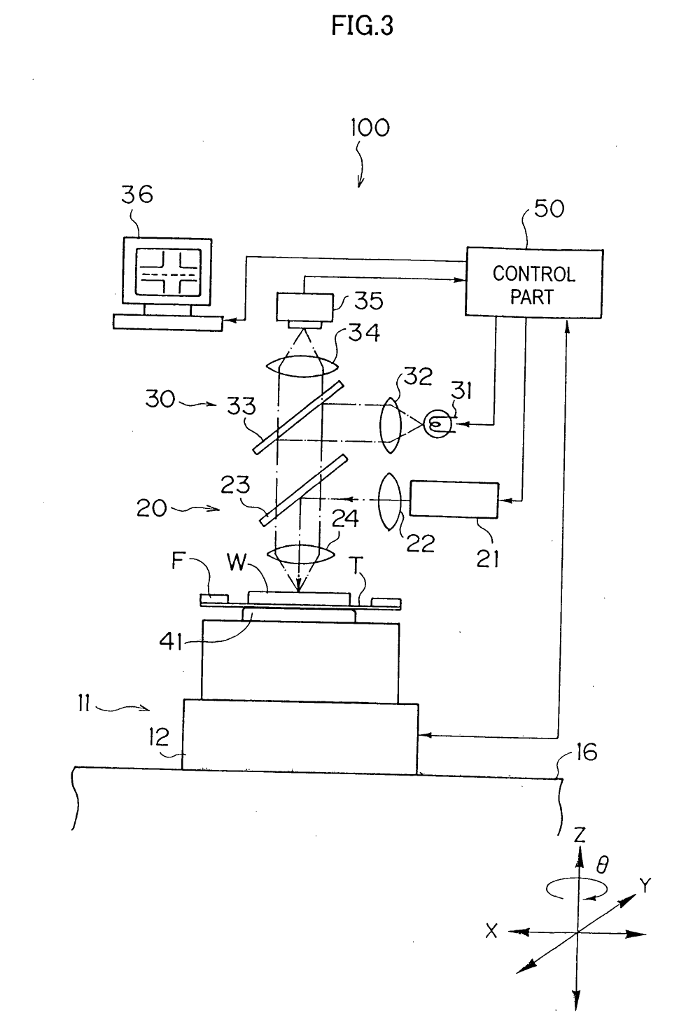

FIG. 3 is a schematic diagram of the configuration of the laser machining part 100. As shown in FIG. 3, the laser machining part 100 comprises a laser optical part 20, an observation optical part 30, a control part 50, etc.

The laser optical part 20 comprises a laser head 21, a collimating lens 22, a semitransparent mirror 23, a condenser lens 24, etc. The observation optical part 30 comprises an observation light source 31, a collimating lens 32, a semitransparent mirror 33, a condenser lens 34, a CCD camera 35 as an observation device, a monitor 36, etc.

In the laser optical part 20, laser light oscillated from the laser head 21 is collected in the interior of the wafer W via optical systems of the collimating lens 22, semitransparent mirror 23 and condenser lens 24, etc. In the laser optical part is used laser light having transmission characteristics with respect to the dicing tape under the conditions of peak power density in a light focusing point of not less than 1×10⁸ (W/cm²) and of pulse width of not more than 1 μs. The Z direction position of the light focusing point is adjusted by the micromotion of the XYZθ table 12 in the Z direction.

In the observation optical part 30, illumination light emitted from the observation light source 31 illuminates the surface of the wafer W via the optical systems of collimating lens 32, semitransparent mirror 33, condenser lens 24, etc. Reflected light from the obverse surface of the wafer W becomes incident upon the CCD camera 35 as the observation device via the condenser lens 24, semitransparent mirrors 23 and 33 and condenser lens 34, and an image of the obverse surface of the wafer W is captured. The captured image data is displayed on the monitor 36 via the control part 50.

The control part 50, which comprises a CPU, a memory, an input/output circuit part, etc., controls the operation of each part of the laser machining part 100.

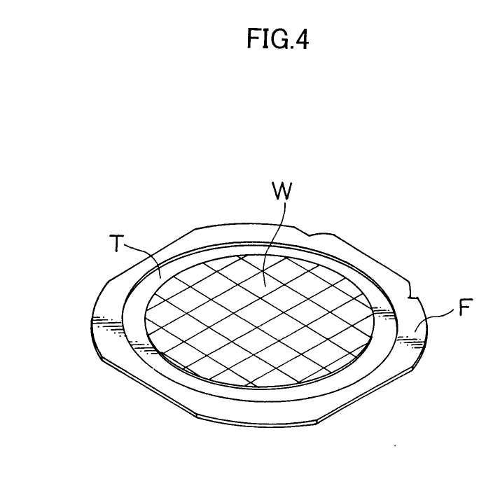

Next, the operation of the die bonder 10 of the present embodiment will be described. First, a wafer W for which an electrical test has been carried out by use of a probing device in the step before the die bonding step, is mounted as shown in FIG. 4 on a ring-shaped frame F via a wafer tape T having an adhesive on one side and transferred to the die bonder 10.

The wafer W is held by suction by the holding stage 13 in this state. A circuit pattern formed on the obverse surface of the wafer W is first captured by the CCD camera 35, and the alignment of the wafer W in the θ direction and its positioning in the XYZ direction are performed by use of an image processing device and an alignment device (not shown).

When the alignment is finished, the XYZθ table 12 moves in the XY directions and laser light L is caused to become incident along the dicing street of the wafer W. At this time, the laser light L may be caused to become incident upon the dicing streets of conforming dies alone on the basis of a conforming die map prepared by the probing device, or may be caused to become incident upon all dies.

Since the light focusing point of the laser light which is caused to become incident from the obverse surface of the wafer W is set in the interior of the wafer W in the thickness direction thereof, the energy of the laser light L which has passed through the obverse surface of the wafer W is concentrated on the light focusing point within the wafer and reformed regions, such as a crack region by multiphoton absorption, a molten region and a region with a changed refractive index, are formed around the light focusing point within the wafer W. As a result of this, the intermolecular balance of the wafer is lost, and dividing occurs naturally with the modified regions serving as initiation points or the wafer becomes divided by applying small external forces.

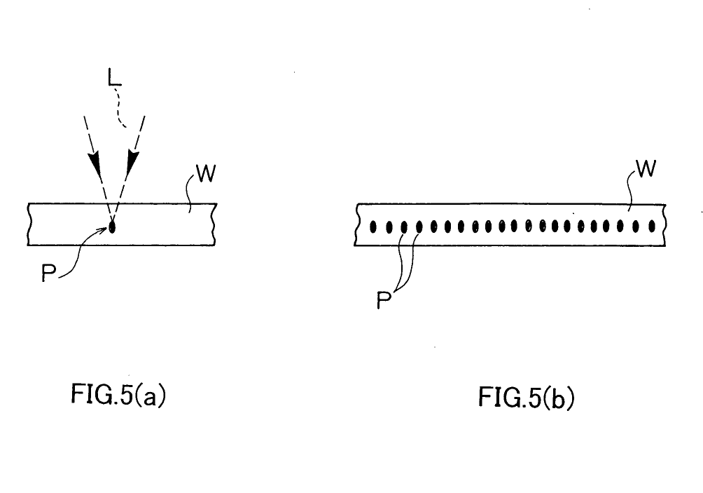

FIGS. 5(a) and 5(b) are schematic diagrams to explain modified regions formed around the light focusing point within a wafer. FIG. 5(a) shows how the laser light L caused to become incident into the interior of the wafer-W forms modified regions P at the light focusing point. FIG. 5(b) shows how the wafer W is transferred in the horizontal direction under laser light L in intermittent pulse form to form discontinuous modified regions P, P, . . . side by side. In this state, dividing occurs naturally with the modified regions P serving as initiation points or the wafer becomes dividable by applying small external forces. In this case, the wafer W is readily divided into chips without the occurrence of chipping on the obverse surface and/or the reverse surface.

When the thickness of the wafer W is large, dividing is hard if the modified regions P have one layer. Therefore, dividing is performed by forming the modified regions P in multiple layers by moving the light focusing point of the laser light L in the thickness direction of the wafer W.

FIG. 5(b) shows how discontinuous modified regions P are formed by laser light L in intermittent pulse form. However, a continuous modified region P may be formed under a continuous wave of laser light L.

In the above-described embodiment, laser machining is performed from the obverse surface side of the wafer W. However, laser machining is not limited to this, and laser light L may be caused to become incident from the reverse surface side of the wafer W. In this case, the laser light L is caused to become incident upon the wafer W after passing through the wafer tape T, or the wafer is stuck to the wafer tape T with the obverse surface of the wafer W facing downward. It is necessary to perform alignment by observing the circuit patterns on the obverse surface of the wafer W by use of light which passes through the wafer W, such as infrared light, from the reverse surface side.

As required, by aligning the light focusing point of laser light L with the top surface of a conforming die, a product type marking is printed on the top surface of the die.

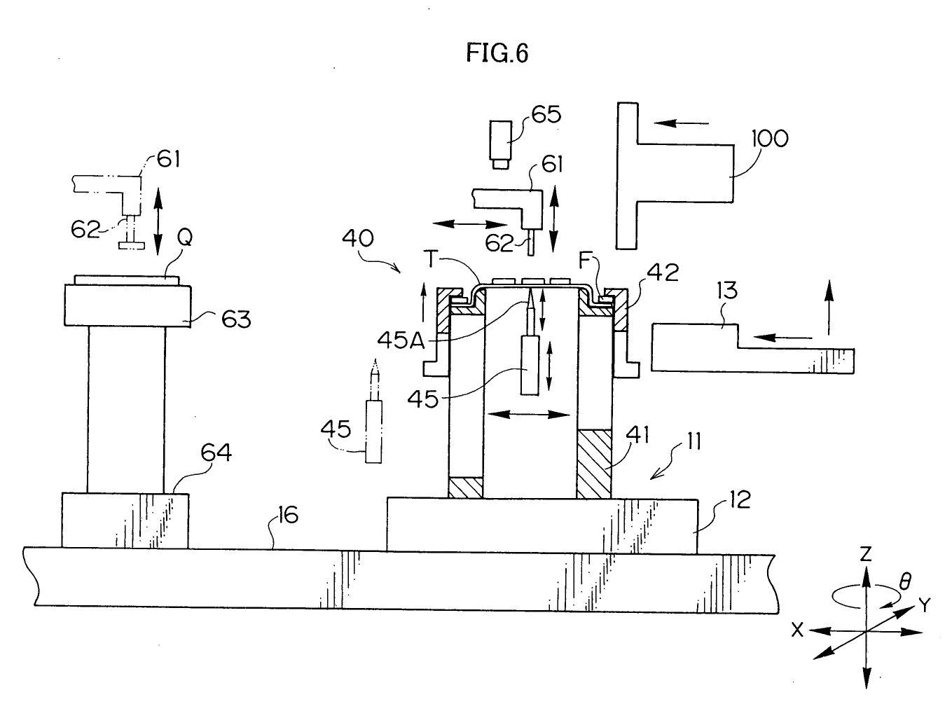

When the laser machining of the wafer W has been finished, the holding stage 13 descends and retreats in the X direction and the expanding of the wafer tape T is performed. FIG. 6 shows this state. As shown in FIG. 6, when the holding stage 13 has retreated, the frame pusher 42 descends and pushes down the frame F.

Since the top edge portion of the expanding stage 41 with which the wafer tape T is in contact is chamfered in circular arc form, the wafer tape T is readily radially expanded at this time, with the result that the gaps between the individual dies divided by laser machining are widened. Even when the wafer W has not been completely divided by laser machining, the wafer W is completely divided into individual dies in this expanding step.

The expanding step can be omitted in a case where in a thin wafer W there is no fear of contact with adjacent dies during the pushup or pickup of dies and hence it is unnecessary to expand the gaps between the dies.

Next, the pushup device 45 is moved in the X direction and Z direction and, as shown in FIG. 6, the pushup device 45 is positioned in the interior of the expanding stage 41. A conforming die is positioned and the target die is pushed up by the needle 45A of the pushup device 45 during the checking of the image by the die recognition camera 65 and picked up from above by use of the collet 62.

As with the expanding step, the die pushing up can also be omitted in a case where in a thin wafer W there is no fear of contact with adjacent dies during the pickup of dies and hence it is unnecessary to expand the gaps between the dies.

The picked-up die is bonded in a bonding position of the base which has been positioned by the base transfer table. A lead frame is frequently used as the base. When bonding is performed, the die is connected to the base by use of bonding materials such as solder, gold and resin.

In this manner, all conforming dies of the wafer W stuck to the wafer tape T are mounted on the base such as a lead frame.

As described above, the die bonder of the present invention has a laser machining part which causes laser light to become incident from the obverse surface of a wafer and forms reformed regions within the wafer, the die bonder itself has the function of dividing the wafer into individual dies and hence it is possible to omit the dicing step before the die bonding step. For this reason, the whole assembly process is simplified, with the result that it is possible to reduce floor space and power consumption. At the same time, it is possible to substantially improve the processing capacity of the whole assembly process.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A die bonder which mounts on a base piece by piece, the dies each having a surface on which a semiconductor device is formed, the die bonder comprising:
a laser machining part which causes laser light to become incident from a surface of a wafer before dividing into individual dies so that the laser light forms a modified region within the wafer,
wherein the wafer is divided into individual dies in the laser machining part.

2. The die bonder as defined in claim 1, wherein a product type marking is provided on a surface of the die by the laser machining part.

3. The die bonder as defined in claim 1, wherein all dies on the wafer are divided into the individual dies by the laser machining part.

4. The die bonder as defined in claim 3, wherein a product type marking is provided on a surface of the die by the laser machining part.

5. The die bonder as defined in claim 1, wherein only conforming dies on the wafer are divided into the individual dies by the laser machining part.

6. The die bonder as defined in claim 5, wherein a product type marking is provided on a surface of the die by the laser machining part.
